(19) United States
(12) Patent Application Publication
(10) Pub. No.: US 2003/0036943 A1
(43) Pub. Date: Feb. 20, 2003

(54) Constituency value exchange optimization method

(76) Inventor: Alan W. H. Grant, Wellesley, MA (US)

Correspondence Address: McDermott Will & Emery, 28 State Street, Boston, MA, 02109-1775, US

(21) Appl. No.: 09/766,698

(22) Filed: Jan. 22, 2001

Related U.S. Application Data
(60) Provisional application No. 60/176,927, filed on Jan. 20, 2000.

(51) Int. Cl. G06F 17/60

(52) U.S. Cl. 705/10; 705/7; 705/14

(57) ABSTRACT

A method of optimizing the value of an entity includes:

A. identifying a number of exchange elements which are offered to a constituent by the entity;

B. associating a cost to the entity with each of the exchange elements;

C. summing the exchange element cost to the entity for the constituent to obtain a total exchange element cost;

D. identifying a number of behaviors of the constituent;

E. associating a value with each of the behaviors;

F. summing the value of the behaviors associated with the constituent to obtain a total behavior value;

G. quantifying the value contributed to the entity by the constituent by subtracting the total exchange element cost from the total behavior value;

H. determining an experience of the constituent to at least one of the exchange elements offered by the entity;

I. obtaining data relative to the constituent's mindset regarding the experience;

J. identifying on or more value exchange gaps based on the data;

K. determining behaviors of the constituent which result from the experience and the mindset data;

L. linking particular exchange elements to particular resulting behaviors of the constituent; and

M. adjusting the exchange elements to cause the constituent to exhibit behaviors which are more valuable to the entity than previous behaviors.

### CROSS -REFERENCED APPLICATION

This application claims priority from U.S. Provisional Patent Application Serial No. 60/176,927, filed Jan. 20, 2000.

### FIELD OF THE INVENTION

This invention relates generally to a method for optimizing a value exchange between a revenue-generating entity and an associated constituent population or subpopulation, and more particularly to a method for increasing the value of the revenue-generating entity by identifying ideal behaviors which, if adopted by the constituent population, will increase the value of the entity It is a methodology that is tangible and unique and creates the capability for intentionally allocating or reallocating investments in the exchanges of value between a revenue generating entity and it's key constituent populations and sub-populations.

### BACKGROUND OF THE INVENTION

There is a transformation taking place in our global and connected economy. This has been typified and explained in many ways. One view is that we are migrating rapidly to a value exchange oriented world. The heart of this transformation is the migration from unintentional optimization to intentional optimization. In the “disconnected economy,” the key processes associated with managing value exchanges between constituents and companies (e.g. between customers and companies) existed but were not effective and efficient (not intentionally managed). In the connected economy, the constituent value web becomes ever more critical to entity success. As we have increasingly migrated to a connected economy, the process for improving constituent value and hence franchise value once again exists however it is not intentionally managed and is hence suboptimal. Optimizing performance in the disconnected economy was a different proposition than it is in the connected economy. Optimizing the exchange of value in the connected economy requires a different point of view around wealth creation, a different enterprise process architecture, different understandings of the cause and effect relationships between investments, experiences, mindsets, behaviors and the economic impact of those behaviors. It requires different understandings (knowledge gained from unique fact and data gathering and analysis) and different capabilities to act on that knowledge.

### SUMMARY OF THE INVENTION

The present invention is directed to a system of optimizing investments in exchanges of value with constituents (customers, employees, suppliers, investors, partners) such that ideal behaviors are evoked, over time, and in doing so enterprise value is optimized. The present invention generally includes three components: (1) a value exchange quantification component (2) a mindset causal modeling component, and, (3) a normative process architecture that serves as a continuous improvement process that links the value exchange quantification component and the mindset causal modeling component.

According to one aspect of the invention, a method of quantifying the value of a constituent population of an entity to the entity includes:

A. identifying a number of exchange elements which are offered to the constituent population (sub-population) by the entity;

B. associating a cost to the entity with each of the exchange elements;

C. summing the exchange element cost to the entity for the constituent population (or sub-population) to obtain a total exchange element cost;

D. identifying a number of behaviors of the constituent population (or sub-population);

E. associating a value with each of the behaviors;

F. summing the value of the behaviors associated with the constituent population (or sub-population) to obtain a total behavior value; and

G. quantifying the value contributed to the entity by the constituent population by subtracting the total exchange element cost from the total behavior value.

According to another aspect of the invention, a method of modeling behaviors of a constituent associated with an entity includes:

A. determining an experience of the constituent to an exchange element offered by the entity;

B. obtaining data relative to the constituent's mindset (attitude) regarding the experience;

C. identifying the data with one or more value exchange gaps based on the data;

D. determining behaviors of the constituent which result from the experience and the mindset data; and

E. linking particular exchange elements to particular resulting behaviors of the constituent such that exchange element adjustments can begin to be planned.

According to yet another aspect of the invention, a method of optimizing the value of an entity includes:

A. identifying a number of exchange elements which are offered to a constituent by the entity;

B. associating a cost to the entity with each of the exchange elements;

C. summing the exchange element cost to the entity for the constituent to obtain a total exchange element cost;

D. identifying a number of behaviors of the constituent;

E. associating a value with each of the behaviors;

F. summing the value of the behaviors associated with the constituent to obtain a total behavior value;

G. quantifying the value contributed to the entity by the constituent by subtracting the total exchange element cost from the total behavior value;

H. determining an experience of the constituent to at least one of the exchange elements offered by the entity;

I. obtaining data relative to the constituent's mindset regarding the experience;

J. identifying one or more value exchange gaps based on the data;

K. determining behaviors of the constituent which result from the experience and the attitude data;

L. linking particular exchange elements to particular resulting behaviors of the constituent; and

M. adjusting the exchange elements to cause the constituent to exhibit behaviors which are more valuable to the entity than previous behaviors.

The invention may also include measuring and evaluating using unique and tangible key performance indicators associated specifically with the invention such that the effectiveness and efficiency of adjustments to exchange elements can be tracked over time.

### BRIEF DESCRIPTION OF THE DRAWINGS

The foregoing and other objects of this invention, the various features thereof, as well as the invention itself may be more fully understood from the following description when read together with the accompanying drawings in which:

FIG. 1 is a block diagram showing the general steps involved in carrying out the method of the present invention;

FIG. 2 is a schematic diagram of a value cube in accordance with the present invention;

FIG. 3 is a block diagram which shows the relationship between constituent experiences and behaviors in accordance with the present invention;

FIG. 4 is a block diagram which shows the impact of constituent experiences on constituent behaviors in accordance with the present invention;

FIG. 5 is a bar graph of the value of the behavior of a constituent in accordance with the present invention;

FIG. 6 is a bar graph of the cost of exchange elements offered to the constituent in accordance with the present invention;

FIG. 7 is a bar graph of a value exchange between the constituent and the entity in accordance with the present invention;

FIG. 8 is a flow diagram showing the activities involved in the method of the present invention; and

FIG. 9 is a block diagram which shows an example of the method in accordance with the present invention.

### DETAILED DESCRIPTION OF THE PREFERRED EMBODIMENTS

In the present connected economy, the present invention enables intentional and optimized value exchanges between constituents and organizations. The invention fills the gap between value exchange improvement capability and enterprise value. In short, the invention provides methods, processes, metrics for intentionally managing the constituent value web, continuously improving constituent value, and hence continuously improving franchise value.

Research has demonstrated that the typical optimization opportunity (difference between current franchise value and full potential franchise value) is somewhere between 5 times and 27 times the current franchise value. Franchise value (relative to the customer constituency) is simply the product of the number of relationships (e.g. number of customers), the average relationship profitability (per year), and the average duration of relationships (in years, as an example). What this suggests is that as our global economy shifts from being disconnected to being connected, entities that remain “disconnected” will have a franchise value that will tend to shrink from their current value, since value exchanges left unintentionally managed will cause an organization to experience a decline in constituent interest, loyalty, and spending.. One can see this happening in many traditional enterprises at the present. On the other hand, intentionally managing value exchanges yields larger franchise value. This will cause a “connected” entity to grow in franchise value by applying, with discipline, the present invention and intentionally and systematically adjusting investments to drive ideal behaviors. A full potential franchise value comes about when the components of the invention are applied to all constituents (customer, employee, suppliers, investors) in the value web.

The invention is directed to a method for optimizing a value exchange between a revenue-generating entity and an associated constituent (customer, employee, supplier, investor) population. Generally, the method involves determining the current franchise value of the entity within a constituent population of the entity, based on a current investment in the constituent population and a current return-on-investment from the constituent population. The current value is determined based on historical behaviors exhibited by the constituent population and the return-on-investment which results from these behaviors. Ideal behaviors which, if adopted by the constituent population will increase the return-on-investment, are identified. A full potential franchise value is forecasted and the gap between the current franchise value and full potential franchise value is determined.

A mindset causal modeling methodology allows for understanding of the drivers of ideal behaviors. These causal models are utilized to design/revise exchange elements on the basis of data/facts/understanding of what is driving behaviors. This understanding is utilized to enhance investments that will causally drive toward ideal behaviors and hence “ideal” value exchange. The value of the ideal behaviors and the investment required to encourage the ideal behaviors are then determined, resulting in a value gap between the historical behaviors and the ideal behaviors. The increase in the return-on-investment resulting from the adoption of the ideal behaviors by the constituent population (more typically a sub-population or segment) in order to close the value gap must be greater than the increase in the investment required to encourage the ideal behaviors. As a result of the adoption of the ideal behaviors by the constituent sub-population, the franchise value of the entity is increased. Examples of revenue-generating entities and their constituent populations include an airline and its passengers, a hotel chain and its guests and a company and its employees and/or suppliers and/or investors and/or channel partners respectively.

At the heart of this invention is the aspect of intentional investments, a scientific approach to altering the “give” (company investments) and the “get” (constituent behaviors). One can think of this intentional investment process as balancing the “give” and the “get.” In order to do this several key components of the invention are required as capabilities in an organization. At a high level, one must be able to define and describe a mutually exclusive and collectively exhaustive set of “gives” (investments in the form of exchange elements) and “gets” (customer behaviors). In the value web point of view the “give” extends beyond the company to the extended enterprise. The capabilities required to perform this give and get analysis and definition do not typically exist in organizations, in fact, the capabilities are rare even at this point in the transformation.

Improving (optimizing) franchise value requires franchise value management capability. Franchise value management capability requires a number of key components: value exchange cost determination; mindset causal modeling; constituent value exchange management process (a model that connects causal understanding of constituent behaviors to exchange element values); systems enablement (process for managing the workflows); and normative enterprise process architecture (franchise value management capabilities). These components of the invention are described in detail below.

It is the disciplined execution of this process that serves to optimize the franchise value through increasingly more intentional investments in constituent value exchanges. To repeat and clarify, the invention includes a method that creates intentional management of constituent value exchanges. The method allows for the migration from unintentional management of value exchanges to intentional management of value exchanges. In the current “disconnected” economy (value chain point of view), mindset causal understanding is shallow to non-existent. Decisioning around how to improve franchise value is not based on continuously improving the value exchange with constituents.

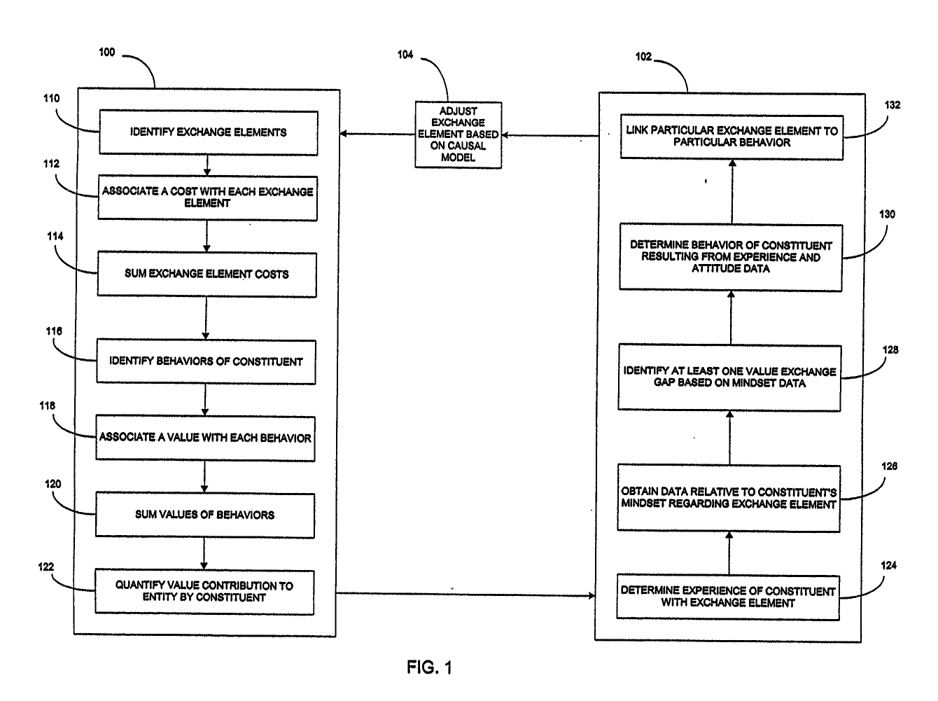

Shown in FIG. 1 is a schematic diagram showing the three components involved in the value exchange optimization method of the present invention. Block 100 includes the value exchange quantification component, block 102 includes the mindset causal modeling component and the combination of blocks 100, 102 and 104 comprises the overall architecture for carrying out the method.

In step 110, a number of exchange elements provide to the constituent by the entity are identified. A cost is then associated with each of the exchange elements, step 112. The costs of all of the exchange elements to the entity are then summed for a particular constituent, and a total exchange element cost id determined, step 114. A number of behaviors of the constituent are identified, step 116 and a value is associated with each behavior, step 118. The values of all of the behaviors is then summed to obtain a total value to the entity of the identified behaviors. The net value contributed to the entity by the constituent or the ROI is then determined by subtracting the total cost from the total value, step 122.

Once the total value of the constituent is determined, the mindset causal model is formed. The entity determines the experience of the constituent with respect to a particular exchange element, step 124. The entity then obtains data from the constituent regarding the attitude or mindset of the constituent which resulted from the experience to the particular exchange element, step 126. The information used in steps 124 and 126 can be obtained from the constituent through interviews, questionnaires, etc. Based on the attitude and experience data obtained, the entity constructs at least one value exchange gap, step 128. As set forth above, these can include a fit gap, a delivery gap, a design gap, an enablement gap and a fairness gap. The gaps generally result from a difference between what is expected by the constituent and what is offered by the entity. The entity then determines a particular behavior exhibited by the constituent as a result of the constituent's experience and attitude toward the entity regarding a particular exchange element, step 130. The entity then links the resulting particular behavior to the particular exchange element that caused the behavior, thus forming the mindset causal model for the constituent, step 132. Based on the knowledge obtained in the model, the entity can then adjust the particular exchange element to cause the desired change in the behavior of the constituent, step 104.

The invention is perhaps best depicted as an improvement cycle process/loop. As set forth above with reference to FIG. 1, the method includes the value exchange quantification component 100, the mindset causal modeling component 102 and the step of optimizing the value exchange between the entity and the constituent population, step 104. The invention enables the entity to identify exchange elements that have the most impact on the mindset of the constituent and to adjust the exchange elements in order to optimize the value exchange.

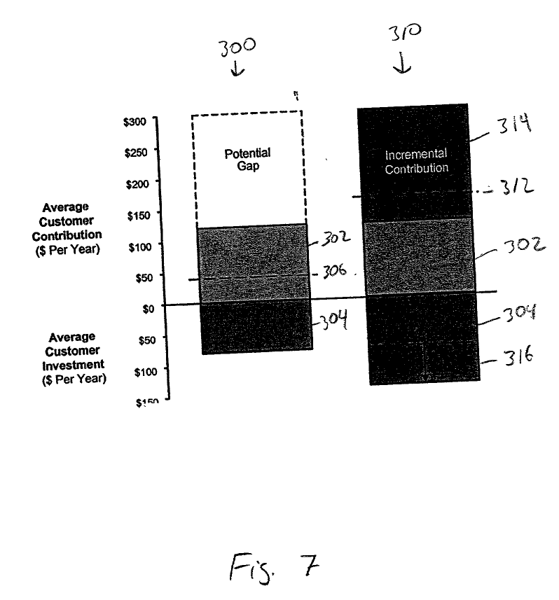

The method of optimizing the value exchange includes four phases each having two stages for optimizing a value exchange between the entity and the constituent population. Each of the stages includes a number of activities, for a total of 37 activities, for determining the criteria necessary for carrying out the method of the present invention. Each of the activities is shown in the flow diagram of FIG. 6 and is described in detail below.

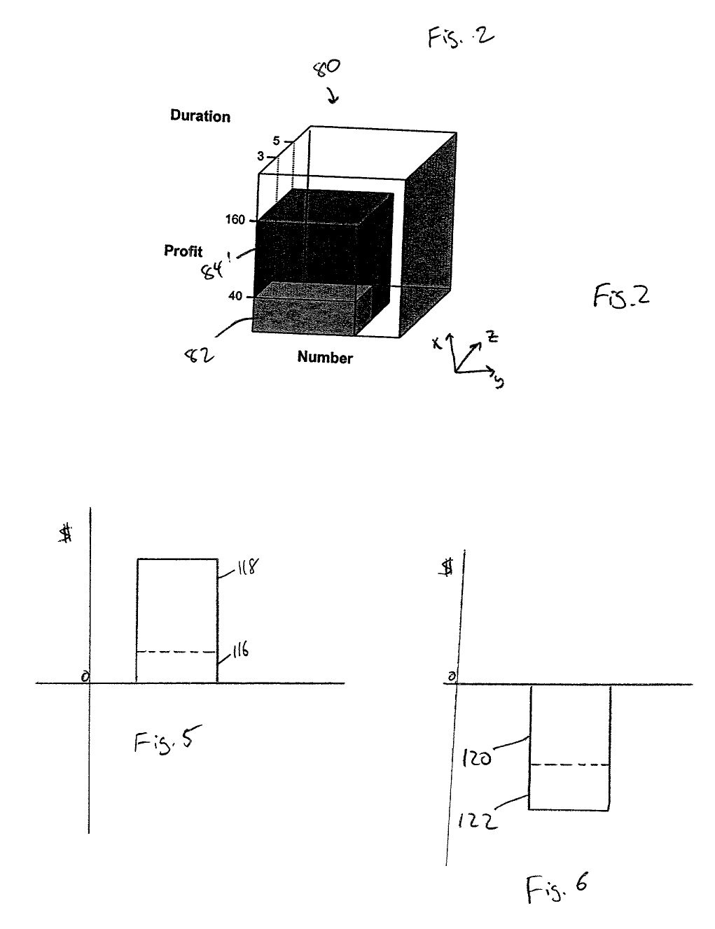

The first phase, called the Define Exchange phase, includes a value potential modeling stage and a goal setting stage. The value potential modeling stage includes five activities which enable the entity to determine who the constituent population of interest is, what they expect from the entity and how their behavior effects the value of the entity. In Activity 1, the constituent population is defined and classified into target segments. This is done by first identifying who the entity is in business to serve. In the case of an airline, the passengers would be the constituent population. The constituent population is then classified into target segments according to the needs and value of each segment. Target segments for the airline could include leisure passengers and business passengers. Further segmentation based on other criteria, such as the amount of the fare paid within each of the segments could also take place. Activity 2 includes determining the needs, behaviors and value of each of the segments. Once the entity knows how the target segments behave and the value to the entity that results from these behaviors, the entity is able to determine which of the behaviors impact the value of the target segments and can then focus on these behaviors when determining how to increase the value of each of the segments. In Activity 3, the entity determines how it should position itself with each of the target segments. In this Activity, the entity, based on its knowledge of the needs and historical behaviors of the constituent population within each segment, determines ideal behaviors which, if adopted by the people in the segment, will increase the value exchange between the entity and the constituent population, thereby increasing the value of the entity. The entity also determines what has been promised to the constituent population, in order to gain a better understanding of the needs of the constituent population or customers and why the customers are exhibiting the historical behaviors. In Activity 4 of the value potential modeling stage, the entity determines who within the entity comes into contact with the customers and can therefore affect the behaviors of the customers. The current entity investment in the target segments is determined based on the information determined in this activity. Activity 5 involves determining the current value of the target segments, as well as the overall entity and quantifying trends in the behaviors of the constituent population. Based on the behavior trends of the constituent population, a potential or target value is determined for both the segments and the entity as a whole. The value of the segment/entity is expressed in a three-dimensional graph, such as is shown at 80 in FIG. 2. As shown in FIG. 2, the X axis depicts the amount of profit, the Y axis depicts the number of people in the constituent population and the Z axis depicts the duration of the average relationship between a person in the constituent population and the entity. Accordingly, in order to increase the value of the entity, either or all of the profit, number of customers and the average duration of the relationship between the customer and the entity will increase the value of the entity. FIG. 2 shows a box 82 which represents the current value of an entity and a box 84 which shows a target value of the entity, based on the current and target values determined in Activity 5. Based on the values, a value difference between the current and target values is recognized.

Once the current and target values are determined and the value difference recognized, the second, goal setting stage is entered. In Activity 6, the linkage between the behavior of the customer and the mindset of the customer is determined. This is done by performing a high level behavior profile for the target segments and identifying potential linkages between types of mindset gaps and the behavior profiles. The mindset gaps represent items and/or services that the customer wants or believes he/she should be getting, but is not, which causes the customer to exhibit certain behaviors. The goal of the invention is to change the mindset of the customer in order to encourage the customer to adopt the ideal behaviors previously identified, thereby increasing one or all of the profit (X axis, FIG. 2) the number of customers (Y axis, FIG. 2) and the duration of the relationship with the entity (Z axis, FIG. 2).

In order to understand or predict full potential return a causal model of behaviors must exist. An understanding of how to actually identify ideal behaviors requires an understanding of the causal linkages between experiences (from exchange elements) and the attitudes that these experiences invoke and the ultimate value creating behaviors. The method associated with mindset causal models involves capturing, systematically, experiences from exchange elements at the constituent level. These experiences invoke attitudes or mindsets. Unique mindset data gathering is utilized to identify five potential types of gaps: (1) a fit gap—a gap between what is offered by the entity and what is needed/wanted/expected by the constituent; (2) a delivery gap—a gap between what is promised by the entity and what is delivered to the constituent; (3) a design or investment gap—a gap between what is designed (in terms of investments in constituents) and the aim of the constituent; (4) an enablement gap—a gap between what the expectations of the constituents and the technological ability of the entity to deliver to the expectations; and (5) a fairness or value gap—a gap between the value exchanged, i.e., what the constituent gives to the entity compared to what the constituent receives from the entity.

Survey research tools are utilized to characterize (with hard data and facts) experiences, gaps, and to then correlate these to tangible behaviors. Actual behaviors are contrasted to ideal behaviors. Understanding from the causal models is applied to formulate hypotheses around investment shifts (exchange element adjustments) and root causes of gaps. Experiments are run to remove or address root causes and data analysis is performed to analyze results. Based on the results of the causal modeling, exchange elements can be added, removed and/or revised, thus causing a change in the behaviors of the constituent toward the ideal behaviors.

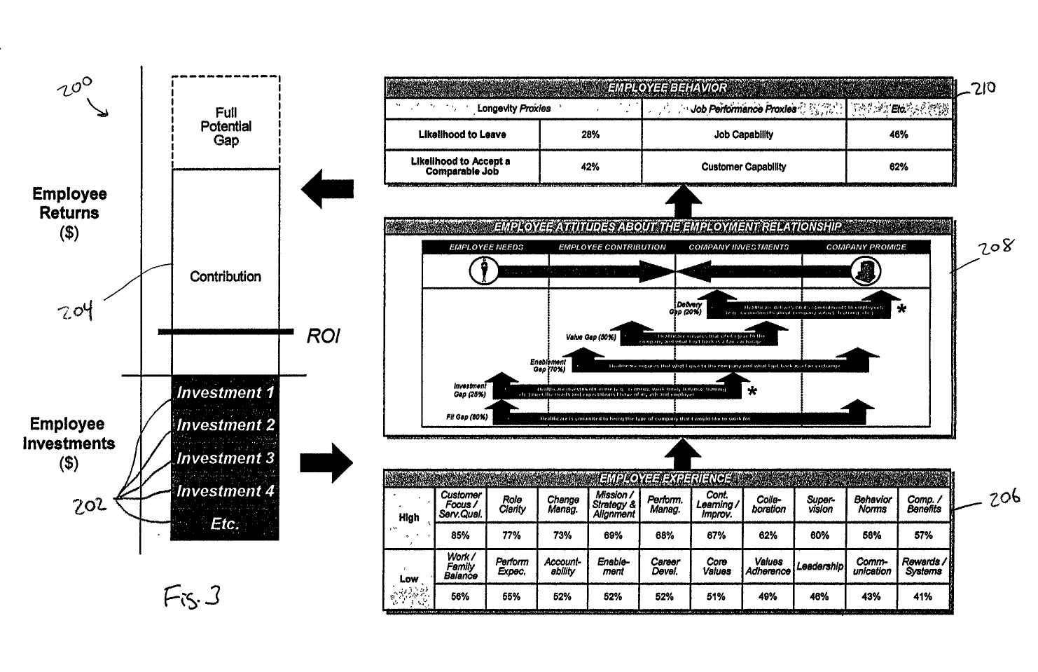

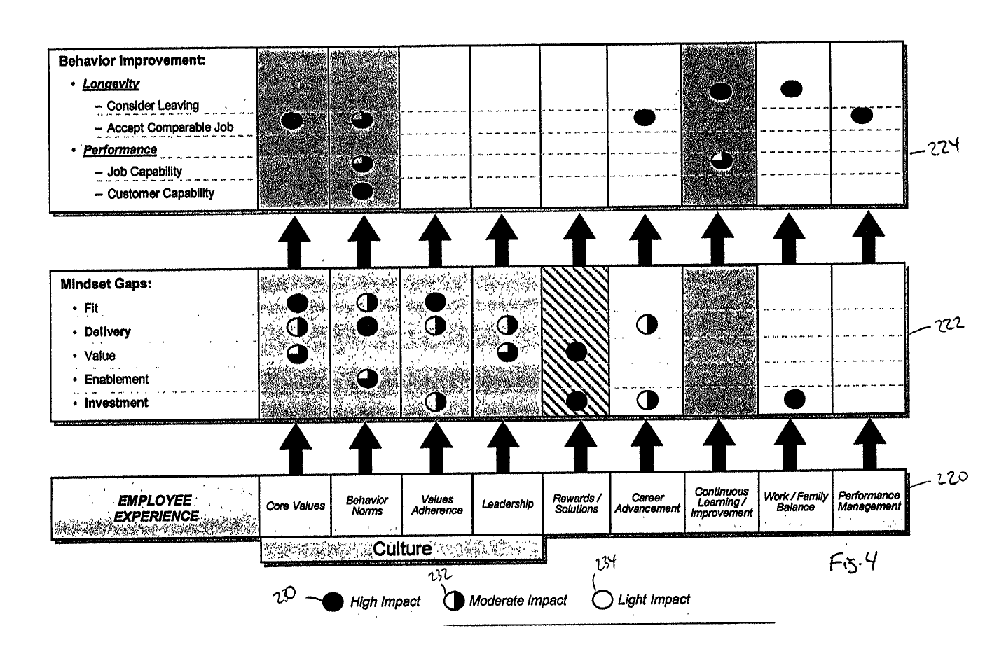

FIGS. 3 and 4 are block diagrams which show how the causal model is formed. Shown at 200 in FIG. 3 is a value exchange bar or VE bar, which compares a number of investments 202 made by the entity in the constituents to the contribution 204 of the constituents to the entity. Each of the investments 202 corresponds to a particular exchange element. The difference between the investments 202 and the contribution 204 is the return-on-investment, ROI. The VE bar is discussed in greater detail below with reference to FIGS. 5-7. Survey research tools are used to obtain data regarding the constituent's experience with each exchange element. In the example shown in FIG. 3, the entity is an employer and the constituent is an employee. Block 206 shows a particular employee's experiences with certain exchange elements. As shown in block 206, higher percentage values indicate a more positive experience, while lower percentage values indicate a less positive experience. Based on this experience data, the mindset or attitude of the employee and his/her relationship with the employer is determined and the mindset gaps are identified, as shown in block 208. As shown in block 208, the five mindset gaps (delivery, value, enablement, investment and fit) between the employee's needs and the employer's promises are identified and quantified. The identification of the mindset gaps enables the employer to form a causal link between the resulting behaviors of the employee and the exchange elements that brought about the resulting behaviors. Based on this causal link, the employer can adjust specific exchange elements to cause a corresponding adjustment in specific behaviors, which adjustment will result in an increase in the employee's contribution to the employer.

FIG. 4 is a block diagram which shows the impact of each of the employee's experiences on each of the mindset gaps and consequently, on each of specific behaviors of the employee. As shown in FIG. 4, an impact of each of the employee experiences shown in block 220 is assigned to the appropriate mindset gaps n block 222. The impact is classified in one of four levels. A fully filled-in circle 230 indicates that the experience has a high impact on the mindset of the employee, a half filled-in circle indicates that the experience has a moderate impact on the mindset of the employee and an unfilled circle indicates that the experience has a light impact on the mindset of the employee. The absence of a circle indicates that the experience has no impact on the mindset of the employee. Once the impact of the experiences of the employee on the mindset gaps are determined, the impact of the mindset gaps on the employee's behaviors are determined, as shown in block 224. The activities involved in obtaining the data are described below.

Activity 7 involves determining the drivers of segment profitability, or what causes the customers to behave in the current manner. These drivers are the exchange elements, as they represent what the entity provides to the constituent in exchange for behaviors from the constituent that add value to the entity. Exchange elements reflect a mutually exclusive and collectively exhaustive list of exchange investments for a given constituent. In Activity 8, the past performance of a segment is used to project a target value baseline based on current segment investments. By holding current trends constant, the segment behaviors and resulting value are able to be forecasted, thus enabling the entity to determine what the target value should be. In Activity 9, the target value for each segment is established based on the information collected in Activities 1-8 and box 114 of the value cube 80 shown in FIG. 2 is constructed. This enables the entity to create quantified goals and plans for each segment and to consolidate segment value improvement goals and financial outcome forecasts. The value cube 80 is continuously updated based on the impact of the goals for each segment. Activity 10 involves forming models based on improvements to the value offered by the constituent population to predict changes in the franchise value of the entity. In this activity, improvements in the number of people in the constituent population, the duration of the relationship between the constituent population and the entity and average profitability are determined based on the segment goals and the ideal behaviors. Based on these factors, the potential franchise value or stock price is determined.

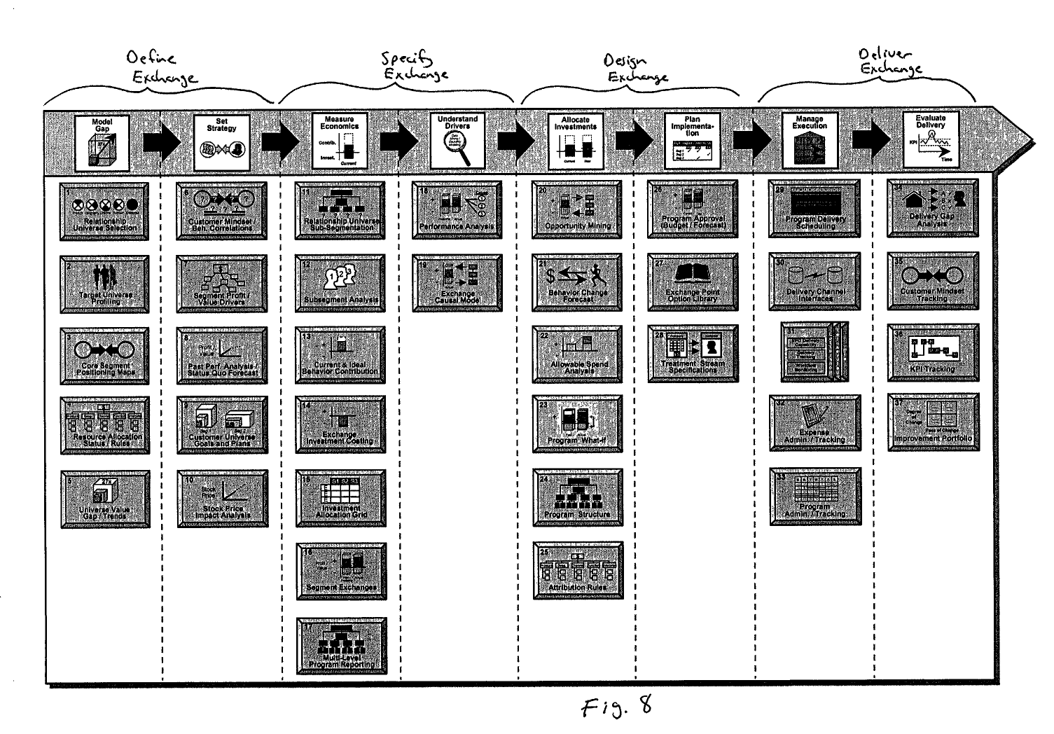

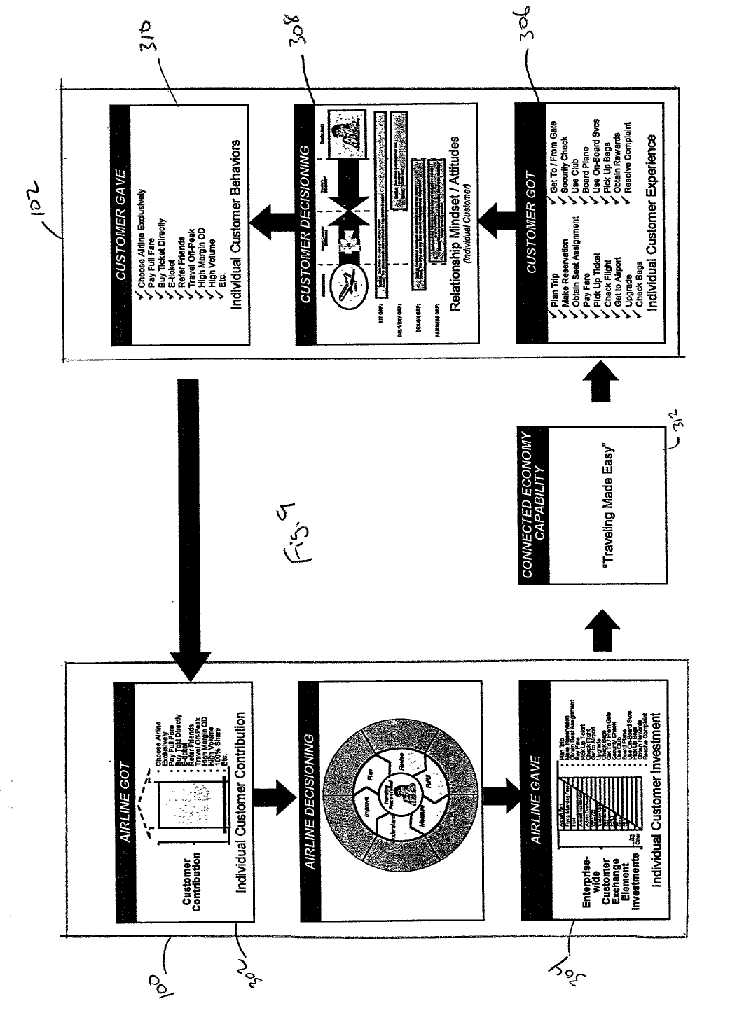

The next component of the method is the Specify Exchange phase, which includes an economics measuring stage (Activities 11-17) and an understanding drivers stage (Activities 18 and 19). The process begins with a data/fact based understanding of the economics of exchanges with segments/sub-segments of constituents. The process quantifies the exchange of value between the two parties. The value exchange is calculated from the perspective of the constituent and is described in economic/financial terms. The value exchange “bar” or VE bar (shown in FIG. 7 and described below) has two components: value returned by the constituent (shown in FIG. 5 and described below) and value invested by the entity (shown in FIG. 6 and described below). Exchange elements is the term used for the components making up the bottom half of the VE bar. As set forth above, exchange elements reflect a mutually exclusive and collectively exhaustive list of exchange investments for a given constituent. Exchange elements are partitioned into behavior impacting and non-behavior impacting interactions. Exchange elements are easily assigned or connected to a specific delivery process. Exchange elements are costed or assigned a value utilizing similar concepts and tools such as Activity Based Costing. The numerator of the VE bar is derived by identifying the observable and observed value contributing behaviors of constituents and applying them to an appropriate value/profitability algorithm. In other words the financial contribution from specific behaviors are identified and quantified. Further, the current actual financial give and get are identified and portrayed in the VE bars by segment or sub-segment. An additional aspect of the process entails estimating the potential “get” (relationship return) or full potential return if ideal behaviors were exhibited. The full potential return is “netted” against the incremental “give” or investment to determine a new projected profit or return-on-investment (ROI) for the segment/sub-segment.

Altered behaviors are tracked and financial analysis is applied to them and the VE bars are revised. This is the Value Exchange Management process piece that links the mindset causal modeling to the Value Exchange Economics piece. In Activity 11, the segments are further broken down into subsegments based on the historical behavior exhibited by the segment and the value gaps between the historical behaviors and the ideal behaviors as specified above. The subsegmentation of the constituent population enables the entity to more precisely determine the drivers that cause the constituent population to behave in the manner that it does, and to determine what needs to be done to encourage the constituent population to adopt the ideal behaviors. Once the subsegments are formed, historical behavior data is maintained at the individual constituent level to allow for historical trending of the subsegments, Activity 12. In Activity 13, the contribution of the subsegment is measured as the sum of the value of their historical behaviors. The sum of the subsegment's potential or target value is also determined based on the adoption of the ideal behaviors by the subsegment population. The value of the subsegments can be illustrated as shown in FIG. 5, which shows a bar graph of the current value 116 contributed by the constituent population and the potential or target value 118. The bar graph of FIG. 5 therefore shows the value gap between the current value and the target value of the constituent population.

Activity 14 involves calculating the investments by the entity in the constituent population. The cost of each exchange element for the subsegment is summed and represented at 120 in a bar graph such as is shown in FIG. 6. The investment required to encourage the subsegment to adopt the ideal behaviors which will result in the increased value of the population is also summed and depicted at 122 in the bar graph of FIG. 6. The sources of all investments in the subsegments are identified in Activity 15 so that each portion of the entity is aware of all other portion that are investing in the constituent population. In Activity 16, the data collected in Activities 13 and 14 is combined to form the bar graph of FIG. 7, which shows at 300 a status quo exchange, wherein a constituent contribution 302 and an entity investment 304 result in a return-on-investment 306. Shown at 310 is aVE bar which illustrates an increased return-on-investment 312 resulting from an increased constituent contribution 314 which resulted from an increased entity investment 316. From the information represented by the bar graph of FIG. 7, the current profit realized from the subsegment can be shown as the difference between the value of the subsegment and the investment in the subsegment. Likewise, the potential or target profit can be determined as the difference between the target value of the subsegment and the investment required to realize the target value from the subsegment. After the VE bar is formed for each subsegment, prior investments in each subsegment are identified and their effectiveness in encouraging the adaptation of ideal behaviors is assessed, Activity 17.

Activity 18, which is the first activity in the understanding drivers stage, involves determining the root causes of segment behaviors through a systematic linking of each investment and the associated mindset driver which results in the particular behavior. Once the root cause of the drivers of particular behaviors is determined, a causal model of the links between exchange elements, customer mindset and the resulting behaviors is built, Activity 19. Building the causal model involves establishing the relationship between the exchange mindset of the customer and the resulting behaviors, establishing a relationship between the exchange mindset of the customer and the entity's exchange investments and establishing a relationship between the investments of the entity and the resulting customer behaviors. The resulting model profiles the behaviors of the customer, the mindset gaps between what the customer wants and what the customer believes he/she is receiving from the entity and the experiences of the customer resulting from the exchange element encountered. The model formed in this activity enables the entity to better understand what drives the customer to behave the way he/she does. Causal modeling leads to adjustments in exchange elements which leads to a unique measurement system that captures the economic impact from behavior shifts.

The next portion is the Design Exchange phase, which includes an investment allocation stage (Activities 20-25) and a Plan Implementation stage (Activities 26-28). Activity 20 involves utilizing the causal model to identify and prioritize improvement opportunities. This is done by identifying high value gaps between the current and ideal behavior profile, identifying the mindset deficiencies driving these behavior gaps and identifying exchange element investments behind each mindset deficiency. Once the above elements are identified, adjustments to certain exchange elements can be made which could potentially change the current behaviors to the ideal behaviors. This activity enables the entity to determine and select which current behavior changes are the most feasible and which will result in the greatest increase in the value returned to the entity. In Activity 21, a behavior change forecast is made. This involves estimating the impact that the exchange elements selected in Activity 20 will have on the current behaviors that affect the value of the entity and developing a forecast of the potential for a change in the current behaviors based on the improvement opportunities identified in Activity 20. In Activity 22, behavior change opportunities are prioritized based on modeled projections from behavior change forecasts. The financial impact of the behavior change forecasts is determined and the value of the behavior change opportunities is used to determine a total allowable subsegment spending level. In Activity 23, the entity determines which exchange elements must be changed and forecasts the resulting behavior changes related to the changes in the exchange elements. Estimates of the investments required to change the selected exchange elements which will result in the desired behavior change and estimates of the return-on-investment are made. When the determination of which exchange elements will be changed is made, a work plan and breakdown structure that allocates the investments to the departments of the entity that are responsible for the exchange elements is developed in Activity 24. In Activity 25, rules are developed which attribute profits to precise departments within the entity that are responsible for the exchange elements whose change has resulted in a change in the value of the entity. This enables the entity to coordinate the various departments within the entity to best develop the profits realized by the entity.

In Activity 26, the specific exchange element adjustments are formalized into a business case to facilitate decision making in the budget approval process. This will enable the entity to develop and input a budget for the program containing the line item detail needed to subsequently track program expenditures. Activity 27 involves detailed planning of the exchange elements that will be adjusted, including determining the migration path of the adjustments. In Activity 28, each of the exchange element adjustments are mapped and exchange element delivery control limitations and rules are specified. KPI's for the delivery, impact and budget of the adjustments are established and delivery channel approval to support the program expectation specification is obtained.

The final portion of the method is the Deliver Exchange phase, which includes an execution management stage (Activities 29-33) and a delivery evaluation stage (Activities 34-37). In Activity 29, the delivery schedule of the program is developed, which involves ensuring that all affected exchange element delivery changes are communicated to all exchange points, communicating the delivery schedules to the delivery channels, ensuring that necessary training for delivery channel execution occurs and to ensure that clear roles responsibilities associated with the exchange element adjustments are established. In Activity 30, the exchange element adjustments are executed. Activity 31 involves tracking the delivery of the exchange element adjustments. In this activity, the effectiveness of the execution of the exchange element adjustments as designed and specified is tracked. This is done by monitoring delivery performance during execution of the exchange elements, reviewing delivery channel performance against the KPI goals and reviewing variances on each KPI between actual performance and target performance. In Activity 32, the efficiency of the execution of the exchange element adjustments as designed and specified is tracked. This includes reviewing the program's current cumulative investments and rolling forecast against the originally approved budget and making adjustments to the investments as needed. In Activity 33, the actual effectiveness and impact of the exchange element adjustments on the current behaviors is tracked. The effectiveness of the adjustments is measured by whether the adjustment increased the number of customers, (X axis, FIG. 2), the duration of the relationship between the customer and the entity (Y axis, FIG. 2) and the amount of profits realized by the entity (Z axis, FIG. 2). This activity integrates the data from Activities 31 and 32 into an overall program progress and performance database for integration purposes. The ongoing tracking of customer investments and behavioral outcomes allows for ongoing relationship continuity and financial optimization.

Activity 34 involves identifying gaps in the delivery and execution of the exchange elements. Executional performance indicators are evaluated and real time adjustments are made to delivery performance. In Activity 35, trends in the mindset of the customer are tracked and shifts in the mindset based on the exchange element adjustments are evaluated. Activity 36 involves evaluating the data from Activity 33 to indicate the actual impact of the exchange element adjustments versus the predicted impact. In this activity, KPI's are established and tracked to evaluate the performance of the constituent value management process. Finally, in Activity 37, initiatives for improving the constituent value management process are prioritized based on the expected returns. It is in this activity that the adjustments made during Activities 34-36 are analyzed and stored for future use to forecast the likely benefits of each adjustment.

FIG. 9 is a block diagram which shows a specific example of the method of the present invention, in which the entity is an airline and the constituent population is a passenger. Shown in block 100 is the value exchange quantification component in which the airline identifies and assigns a value to specific behaviors of the passenger in block 302 and identifies and assigns a value to investments or exchange elements in block 304. As shown in block 304 exchange elements include trip and flight planning, baggage handling, airline club use, etc. Shown in block 102 is the mindset causal modeling component in which the airline determines the experience of the passenger with respect to each of the exchange elements in block 306, determines the mindset of the passenger as a result of the experiences in block 308 and determines the resulting behaviors of the passenger in block 310. As shown in block 310, passenger behaviors include flying that airline exclusively, referring friends to the airline, paying full fare, etc. In block 312, the airline can make adjustments to the exchange elements to affect the experiences and ultimately the resulting behaviors of the passenger. For example, if it were found that use of the airline club during layovers caused passengers to fly exclusively with the airline or to pay a higher fare, the airline could increase the availability of the club to more passengers, thus causing more passengers to tend to use the airline exclusively and/or to pay higher fares.

Accordingly, the present invention is a method which enables a revenue-generating entity to increase its franchise value by analyzing how an associated constituent population behaves and the value of such behavior to the entity. The entity then identifies ideal behaviors which, if adopted by the constituent population, have the potential to increase the franchise value of the entity. Once the ideal behaviors are identified, the entity determines what exchange elements must be adjusted to encourage the constituent population to adopt the ideal behaviors. The investment required to adjust the exchange elements is compared to the expected increase in the return-on-investment which results from the adoption of the ideal behaviors to determine the increase in the franchise value of the entity. The method is a continuous process and adjustments are made in real time in order to address deviations from the expected value determinations. The method can be applied to any relationship in which an entity invests in a constituent population which in turn contributes to the entity, thus adding value to the entity. Such relationships include an common carrier and its passengers, an employer and its employees, a retail outfit and its customers, etc.

The invention may be embodied in other specific forms without departing from the spirit or essential characteristics thereof. The present embodiments are therefore to be considered in respects as illustrative and not restrictive, the scope of the invention being indicated by the appended claims rather than by the foregoing description, and all changes which come within the meaning and range of the equivalency of the claims are therefore intended to be embraced therein.

1. A method of quantifying the value of a constituent population of an entity to the entity comprising:
A. identifying a number of exchange elements which are offered to the constituent population by the entity;
B. associating a cost to the entity with each of said exchange elements;
C. summing the exchange element cost to the entity for said constituent population to obtain a total exchange element cost;
D. identifying a number of behaviors of said constituent population;
E. associating a value with each of said behaviors;
F. summing the value of the behaviors associated with the constituent population to obtain a total behavior value; and
G. quantifying the value contributed to said entity by said constituent population by subtracting the total exchange element cost from the total behavior value.

2. The method of claim 1 further comprising:
H. determining an experience of said constituent to at least one of said exchange elements offered by said entity;
I. obtaining data relative to said constituent's mindset regarding said experience;
J. constructing at least one value exchange gap based on said data;
K. determining behaviors of said constituent which result from said experience and said mindset data;
L. linking particular exchange elements to particular resulting behaviors of said constituent; and
M. adjusting said exchange elements to cause said constituent to exhibit behaviors which are more valuable to the entity than previous behaviors.

3. The method of claim 2 further compring tracking the value attributed to said adjusted exchange elements over time.

4. A method of modeling behaviors of a constituent associated with an entity comprising:
A. determining an experience of said constituent to an exchange element offered by said entity;
B. obtaining data relative to said constituent's mindset regarding said experience;
C. identifying one or more value exchange gaps based on said data;
D. determining behaviors of said constituent which result from said experience and said mindset data; and
E. linking particular exchange elements to particular resulting behaviors of said constituent.

5. The method of claim 3 further comprising:
F. associating a cost to the entity with each of said exchange elements;
G. summing the exchange element cost to the entity for said constituent to obtain a total exchange element cost;
H. associating a value with each of said behaviors;
I. summing the value of the behaviors associated with said constituent to obtain a total behavior value; and
J. quantifying the value contributed to said entity by said constituent by subtracting the total exchange element cost from the total behavior value.

6. The method of claim 5 further compring tracking the value attributed to said adjusted exchange elements over time.

7. A method of optimizing the value of an entity comprising:
A. identifying a number of exchange elements which are offered to a constituent by the entity;
B. associating a cost to the entity with each of said exchange elements;
C. summing the exchange element cost to the entity for said constituent to obtain a total exchange element cost;
D. identifying a number of behaviors of said constituent;
E. associating a value with each of said behaviors;
F. summing the value of the behaviors associated with said constituent to obtain a total behavior value;
G. quantifying the value contributed to said entity by said constituent by subtracting the total exchange element cost from the total behavior value;
H. determining an experience of said constituent to at least one of said exchange elements offered by said entity;
I. obtaining data relative to said constituent's mindset regarding said experience;
J. identifying one or more value exchange gaps based on said data;
K. determining behaviors of said constituent which result from said experience and said mindset data;
L. linking particular exchange elements to particular resulting behaviors of said constituent; and
M. adjusting said exchange elements to cause said constituent to exhibit behaviors which are more valuable to the entity than previous behaviors.

8. The method of claim 7 further compring tracking the value attributed to said adjusted exchange elements over time.
